(19) United States
(12) Patent Application Publication
(10) Pub. No.: US 2026/0292047 A1
(43) Pub. Date: Sep. 24, 2026

(54) DATA TRANSMISSION METHOD, DEVICE AND MEDIUM

(71) Applicant: Beijing Volcano Engine Technology Co., Ltd., Beijing (CN)

(72) Inventors: Jing LUO, Beijing (CN); Songyuan GUAN, Beijing (CN); Jianbin LI, Beijing (CN)

(21) Appl. No.: 19/427,359

(22) Filed: Dec. 19, 2025

(30) Foreign Application Priority Data
Mar. 24, 2025 (CN) 202510353699.8

(51) Int. Cl. H04L 69/16; H04L 9/40; H04L 45/655

(52) U.S. Cl. CPC H04L 69/162; H04L 45/655; H04L 63/029

(57) ABSTRACT

The present application provides a data transmission method, a device and a medium. The method is applied to a first device, wherein a first application process and a first socket interface of the first application process run in the first device, and the first socket interface is associated with a network interface card device connected to the first device, and the method includes: receiving a first data packet sent by the network interface card device; processing the first data packet to generate a first data message, and determining the first socket interface according to session information indicated by the first data packet; sending the first data message to the first socket interface, such that the first application process reads the first data message based on the first socket interface.

### CROSS-REFERENCE TO RELATED APPLICATIONS

This application claims the priority to and benefits of the Chinese patent application No. 202510353699.8 filed on Mar. 24, 2025. The entire contents disclosed in the aforementioned patent application are hereby incorporated by reference as part of this application.

### TECHNICAL FIELD

The present application relates to the field of computer technologies, and in particular, to a data transmission method and apparatus, an electronic device, a computer-readable storage medium, and a computer program product.

### BACKGROUND

With the continuous development of computer technologies and network technologies, network traffic is continuously increasing, and a cloud firewall service provided by a network security product can perform security management on the network traffic. The network traffic may be understood as data packets transmitted between a server and a client (for example, an application process running in a computing device), and the network traffic may be transmitted through a network interface card device connected to the computing device. Using an example in which an application process reads data, the server generates a data packet and sends the data packet to the cloud firewall service through the network interface card device, and the cloud firewall service identifies the data packet and sends a data packet confirmed to be secure to the application process, to complete data reading.

The application process runs in a user mode of an operating system of the computing device. Generally, during a process of data transmission between the application process and the server, a context switch between a kernel mode and the user mode needs to be frequently performed through an interrupt, which greatly consumes resources of the cloud firewall service and reduces performance of the cloud firewall service. How to improve the performance of the cloud firewall service while ensuring stable data transmission becomes an urgent problem to be solved

### SUMMARY

The present application provides a data transmission method. The method is applied to a first device. A cloud firewall service, a first application process, and a first socket interface of the first application process run in a user mode of an operating system of the first device. A data forwarding process and a user- mode protocol stack corresponding to the first application process run in the cloud firewall service. The first socket interface is associated with a network interface card device connected to the first device. The method includes the following steps:

The data forwarding process of the cloud firewall service receives a first data packet sent by the network interface card device, and forwards the first data packet to the user-mode protocol stack.

The user-mode protocol stack of the cloud firewall service processes the first data packet to generate a first data message, and determines the first socket interface according to session information indicated by the first data packet.

The user-mode protocol stack of the cloud firewall service sends the first data message to the first socket interface, so that the first application process reads the first data message based on the first socket interface.

The present application provides a data transmission method. The method is applied to a first device. A cloud firewall service, a first application process, and a first socket interface of the first application process run in a user mode of an operating system of the first device. A data forwarding process and a user-mode protocol stack corresponding to the first application process run in the cloud firewall service. The first socket interface is associated with a network interface card device connected to the first device. The method includes the following steps:

In response to the first application process writing a second data packet based on the first socket interface, the user-mode protocol stack of the cloud firewall service processes the second data packet to generate a second data message, and determines the network interface card device according to session information indicated by the second data packet.

The user-mode protocol stack of the cloud firewall service sends the second data message to the data forwarding process.

The data forwarding process of the cloud firewall service sends the second data message to the network interface card device.

The present application provides a data transmission apparatus. The apparatus is deployed in a first device. A cloud firewall service, a first application process, and a first socket interface of the first application process run in a user mode of an operating system of the first device. A data forwarding process and a user-mode protocol stack corresponding to the first application process run in the cloud firewall service. The first socket interface is associated with a network interface card device connected to the first device. The apparatus includes:

A communication module, configured to receive a first data packet sent by the network interface card device, and forward the first data packet to the user-mode protocol stack.

A processing module, configured to process the first data packet to generate a first data message, and determine the first socket interface according to session information indicated by the first data packet.

The communication module is further configured to send the first data message to the first socket interface, so that the first application process reads the first data message based on the first socket interface.

The present application provides a data transmission apparatus. The apparatus is deployed in a first device. A cloud firewall service, a first application process, and a first socket interface of the first application process run in a user mode of an operating system of the first device. A data forwarding process and a user-mode protocol stack corresponding to the first application process run in the cloud firewall service. The first socket interface is associated with a network interface card device connected to the first device. The apparatus includes:

A processing module, configured to in response to the first application process writing a second data packet based on the first socket interface, process the second data packet to generate a second data message, and determine the network interface card device according to session information indicated by the second data packet.

A communication module, configured to send the second data message to the data forwarding process.

The communication module is further configured to send the second data message to the network interface card device.

The present application provides an electronic device. The electronic device includes a processor and a memory. The processor and the memory communicate with each other. The processor is configured to execute instructions stored in the memory, to enable the electronic device to perform the data transmission method according to any implementation of the present disclosure.

The present application provides a computer-readable storage medium. The computer-readable storage medium stores instructions, and the instructions instruct an electronic device to perform the data transmission method according to any implementation of the present disclosure.

The present application provides a computer program product that includes instructions. When the computer program product runs on an electronic device, the electronic device is enabled to perform the data transmission method according to any implementation of the present disclosure.

In the present application, based on the implementations provided in the foregoing embodiments, further combination may be performed to provide more implementations.

It may be learned from the foregoing technical solutions that the present application has the following advantages.

### BRIEF DESCRIPTION OF DRAWINGS

To describe the technical methods in embodiments of the present application more clearly, the following briefly describes the drawings used in describing the embodiments.

FIG. 1 is a schematic flowchart of a data transmission method according to embodiments of the present application;

FIG. 2 is a schematic diagram of interaction between a network interface card device and a user mode according to embodiments of the present application;

FIG. 3 is a schematic flowchart of a data transmission method according to embodiments of the present application;

FIG. 4 is a schematic flowchart of a data transmission method according to embodiments of the present application;

FIG. 5 is a schematic diagram of a structure of a data transmission apparatus according to embodiments of the present application;

FIG. 6 is a schematic diagram of a structure of a data transmission apparatus according to embodiments of the present application; and

FIG. 7 is a schematic diagram of a structure of an electronic device according to embodiments of the present application.

### DETAILED DESCRIPTION

The terms "first" and "second" in the embodiments of the present application are used for descriptive purposes only, and cannot be construed as indicating or implying relative importance or implicitly indicating the number of technical features indicated. Therefore, a feature defined as "first" or "second" may explicitly or implicitly include one or more features.

First, some technical terms and application scenarios involved in the embodiments of the present application are described.

With the continuous development of computer technologies and network technologies, network traffic is continuously increasing, and a cloud firewall service provided by a network security product can perform security management on the network traffic. The network traffic may be understood as data packets transmitted between a server and a client (for example, an application process running in a computing device), and the network traffic may be transmitted through a network interface card device connected to the computing device.

In a scenario in which an application process reads data, the server generates a data packet and sends the data packet to the cloud firewall service through the network interface card device, and the cloud firewall service identifies the data packet and sends a data packet confirmed to be secure to the application process, to complete data transmission. In a scenario in which an application process writes data, the cloud firewall service identifies a data packet written by the application process, and sends a data packet confirmed to be secure to the network interface card device, so that the network interface card device sends the data packet confirmed to be secure to the server, to complete data writing.

A Linux system is divided into a kernel mode and a user mode, and the kernel mode and the user mode may be understood as two modes in the Linux system for distinguishing running states of processes. Specifically, a kernel mode is a state in which an operating system kernel and a process with the highest privilege run, and the kernel mode has full access permission to system resources, that is, the kernel mode may execute any instruction and access any memory address, and is usually used to run core functions of the operating system, such as process management, memory management, and interrupt handling. A user mode is a state in which a general application runs, and access of the user mode to the system resources is restricted, that is, the user mode cannot directly execute an operation involving system management, and is usually used to run an application process of the application. Through the division between the kernel mode and the user mode, the application is prevented from destroying a core of the operating system, and stability and security of the operating system are ensured.

There is a switching mechanism between the kernel mode and the user mode. Generally, when a process in the user mode needs to perform an operation that requires kernel permission, the switch from the user mode to the kernel mode may be triggered through a system call. Specifically, during a process of data transmission between an application process and a server, a context switch between the kernel mode and the user mode needs to be frequently performed through an interrupt.

Using an example in which an application process reads, from a network interface card device, a data packet generated by a server, when the data packet arrives, the network interface card device reads the data packet into a memory buffer, and notifies a central processing unit (CPU) through an interrupt that the data packet arrives. The CPU responds to the interrupt, enters a kernel mode, and executes an interrupt handler to copy the data packet from the memory buffer of the network interface card device to a protocol stack (for example, a network protocol stack running in the kernel mode) running in the kernel mode for data processing, to generate a data message. Because the application process runs in a user mode and cannot directly access a hardware resource (that is, the network interface card device), when the application process needs to read the data message from the network interface card device, the application process may trigger an interrupt by calling a system call (for example, read), so that the CPU switches from the user mode to the kernel mode. A system call handler in the kernel mode obtains the data message from the kernel protocol stack, and copies the data message to a socket interface of the application process in the kernel mode. After the data copying is completed, the CPU switches from the kernel mode back to the user mode, and the application process may read the data message from the socket interface, to complete a data reading process.

Where, the protocol stack may be understood as a set of protocols related to network communication. For example, when the protocol stack is a network protocol stack, in the network protocol stack based on a TCP/IP model, protocols from bottom to top respectively include a link layer protocol, a network layer protocol, a transport layer protocol, and an application layer protocol. The link layer protocol may be specifically an Ethernet protocol, the network layer protocol may be specifically an internet protocol (IP), an address resolution protocol (ARP), or the like, the transport layer protocol may be specifically a transmission control protocol (TCP), a user data gram protocol (UDP), or the like, and the application layer protocol may be specifically a hypertext transfer protocol (HTTP), a file transfer protocol (FTP), a trivial file transfer protocol (TFTP), or the like. By running the protocol stack in the Linux system, the data transmission process is modularized and standardized, and efficient and reliable data transmission in the Linux system is implemented.

The socket interface may be understood as an interface for interaction between the application process and the protocol stack. Specifically, the socket interface is created by the application process, and the socket interface is represented by a file descriptor in the user mode and corresponds to a series of complex data structures and resources in the kernel mode. The socket interface abstracts complex implementation details in the data transmission process into an interface, so that the application process may perform data transmission in a file operation manner.

The foregoing context switch operation performed during the data transmission process greatly consumes resources of the cloud firewall service and reduces performance of the cloud firewall service. How to improve the performance of the cloud firewall service while ensuring stable data transmission becomes an urgent problem to be solved.

In view of this, the present application provides a data transmission method. The method may reduce resource consumption of a cloud firewall service during a data transmission process, and improve performance of the cloud firewall service. The present application further provides an apparatus, an electronic device, a computer-readable storage medium, and a computer program product that correspond to the foregoing method.

The present application provides a data transmission method. The method is applied to a first device. A cloud firewall service, a first application process, and a first socket interface of the first application process run in a user mode of an operating system of the first device. A data forwarding process and a user-mode protocol stack corresponding to the first application process run in the cloud firewall service. The first socket interface is associated with a network interface card device connected to the first device. First, the data forwarding process receives a first data packet sent by the network interface card device, and forwards the first data packet to the user-mode protocol stack. Then, the user-mode protocol stack processes the first data packet to generate a first data message, determines the first socket interface according to session information indicated by the first data packet, and sends the first data message to the first socket interface, so that the first application process reads the first data message based on the first socket interface.

In the method, for a scenario in which an application process reads data, by integrating the data forwarding process and the user-mode protocol stack into the cloud firewall service, a data packet is directly mapped to the user mode, and processing of the data packet and forwarding of the data packet to the application process are implemented in the user mode. A process in which the data packet is delivered to the application process does not need to go through a kernel mode, which reduces resource consumption of the cloud firewall service caused by a context switch, and improves performance of the cloud firewall service.

Correspondingly, the present application further provides a data transmission method. The method is applied to a first device. A cloud firewall service, a first application process, and a first socket interface of the first application process run in a user mode of an operating system of the first device. A data forwarding process and a user-mode protocol stack corresponding to the first application process run in the cloud firewall service. The first socket interface is associated with a network interface card device connected to the first device. First, in response to the first application process writing a second data packet based on the first socket interface, the user-mode protocol stack processes the second data packet to generate a second data message, determines the network interface card device according to session information indicated by the second data packet, and sends the second data message to the data forwarding process. Then, the data forwarding process sends the second data message to the network interface card device.

In the method, for a scenario in which an application process writes data, by integrating the data forwarding process and the user-mode protocol stack into the cloud firewall service, processing of a data packet and forwarding of the data packet to a network interface card device are implemented in a user mode. A process in which the data packet is sent to a server does not need to go through a kernel mode, which reduces resource consumption of the cloud firewall service caused by a context switch, and improves performance of the cloud firewall service.

To help understand the technical solutions provided in the embodiments of the present application, the following descriptions are made with reference to the drawings.

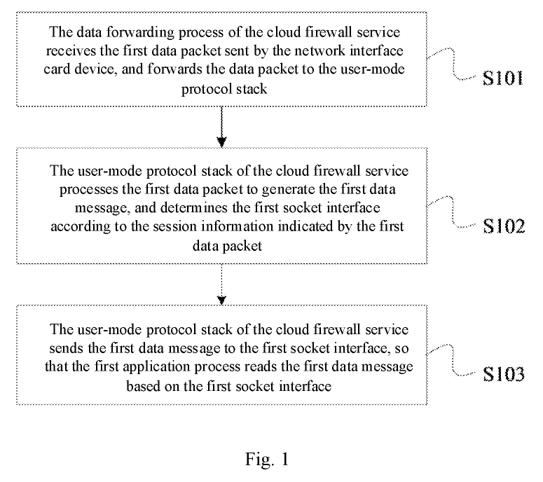

FIG. 1 is a schematic flowchart of a data transmission method. The method may be applied to a first device. A cloud firewall service, a first application process, and a first socket interface of the first application process run in a user mode of an operating system of the first device. A data forwarding process and a user-mode protocol stack corresponding to the first application process run in the cloud firewall service. The first socket interface is associated with a network interface card device connected to the first device.

Where, the first device may be understood as a party in a data transmission process. For example, when the first device needs to read data, the first device may correspond to a data receiver; or when the first device needs to write data, the first device may correspond to a data sender. The first application process may be understood as an application process of any application running in the user mode of the operating system of the first device, and the first application process may have a data transmission requirement.

In embodiments of the present application, different from a traditional cloud firewall service in which only a data forwarding process runs, both the data forwarding process and the user-mode protocol stack run in the cloud firewall service. The data forwarding process may be understood as a process for providing a data filtering and forwarding function, and the user-mode protocol stack may be understood as a protocol stack implemented in the user mode. In other words, in the user mode of the operating system of the first device, a corresponding user-mode protocol stack is deployed for the first application process, and the user-mode protocol stack may be used by the first application process for data transmission. Because the user-mode protocol stack runs in the user mode, the first socket interface created by the first application also runs in the user mode.

In embodiments of the present application, an implementation of the user-mode protocol stack in the first device is not limited. For example, the user-mode protocol stack may be created based on a data plane development kit (DPDK).

The method specifically includes the following steps.

S101: The data forwarding process of the cloud firewall service receives a first data packet sent by the network interface card device, and forwards the first data packet to the user-mode protocol stack.

The first data packet may be an original data packet generated by the server. In other words, a data reading requirement of the first application process is a requirement for reading the first data packet. A data transmission process between the server and the first application process depends on the network interface card device, that is, the first data packet generated by the server is first read into the memory buffer of the network interface card device, and then the network interface card device sends the first data packet to the first application process.

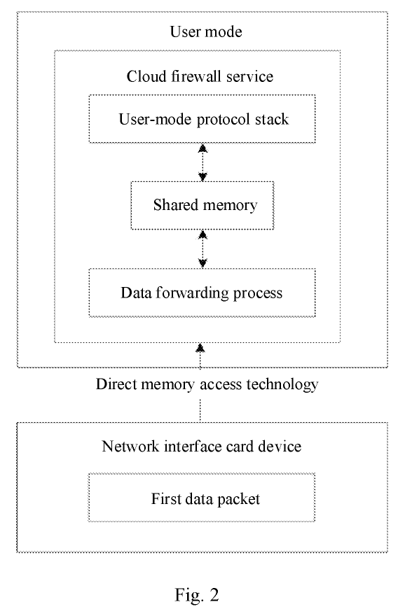

The data interaction process is described in detail below with reference to FIG. 2, which is a schematic diagram of interaction between a network interface card device and a user mode. In embodiments of the present application, the cloud firewall service may play a role of an intermediary between the network interface card device and the first application process, and establish a connection with the network interface card device and a connection with the first application process, respectively.

Because the network interface card device is an external device independent of the first device, the network interface card device cannot directly interact with the cloud firewall service in the user mode of the operating system of the first device. In embodiments of the present application, interaction between the network interface card device and the cloud firewall service is implemented through a direct memory access (DMA) technology. That is, the data forwarding process of the cloud firewall service may receive the first data packet sent by the network interface card device based on the DMA technology.

The DMA technology is a computer data transmission technology that allows an additional device to directly perform data interaction with a system memory. After the DMA technology is applied, on one hand, the network interface card device may directly perform the transmission of the first data packet with the user mode of the operating system of the first device without a context switch between the kernel mode and the user mode, and on the other hand, CPU resources are not occupied a, which reduces a burden of the CPU for processing the first data packet.

After receiving the first data packet, the data forwarding process may filter the first data packet. Specifically, the data forwarding process of the cloud firewall service filters the first data packet based on a preset filtering rule, and forwards the first data packet allowed to pass to the user-mode protocol stack.

In other words, by parsing the first data packet, the data forwarding process may perform access control list (ACL) matching on the first data packet, determine whether the first data packet is secure, send the first data packet confirmed to be secure to the user-mode protocol stack, and discard an insecure first data packet. As such, the security management function of the cloud firewall service is implemented, preventing an insecure data packet from being transmitted to the application process, and ensuring running security of the application process.

Because the data forwarding process and the user-mode protocol stack belong to two different processes in the user mode and cannot perform a direct transmission of a data packet, in the cloud firewall service, for the first data packet allowed to pass, the data forwarding process may inject the first data packet allowed to pass into the user-mode protocol stack through shared memory, so that the user-mode protocol stack performs data processing on the first data packet.

S102: The user-mode protocol stack of the cloud firewall service processes the first data packet to generate a first data message, and determines the first socket interface based on session information indicated by the first data packet.

After receiving the first data packet, the user-mode protocol stack may process the first data packet. For example, the user-mode protocol stack parses and assembles the first data packet based on a set of protocols related to a network communication process in the protocol stack, and re-organizes and mounts the first data packet into an ordered queue to form a data message that meets a data transmission protocol.

The user-mode protocol stack may further parse the first data packet to obtain the session information, for example, five-tuple information (that is, a source IP address, a source port, a destination IP address, a destination port, and a transport layer protocol). Then, the destination port in the five-tuple information is matched against interfaces corresponding to each application process in the first device, to determine a data receiver (that is, the first application process) for the first data packet. Further, the first socket interface for data transmission between the first application process and the network interface card device is determined based on a socket interface associated with the first application process.

S103: The user-mode protocol stack of the cloud firewall service sends the first data message to the first socket interface, so that the first application process reads the first data message based on the first socket interface.

After completing processing of the first data packet and generating the first data message, the user-mode protocol stack sends the first data message to the first socket interface. Because the first application process needs to complete the corresponding data transmission process through the first socket interface, the user-mode protocol stack sending the first data message to the first socket interface may be understood as triggering a data reading event of the first application process, that is, there is a data message to be read in the first socket interface, the first socket interface meets a trigger condition of the data reading event, and the first application process may read data.

In a scenario of a traditional kernel-mode protocol stack, a process in which an application process performs data transmission through a socket interface may be completed in a synchronous manner or an asynchronous manner. Using data reading as an example, in synchronous data reading, the application process calls a read function or a recv function, and blocks to wait for a data message to arrive at the socket interface. When the data message arrives at the socket interface, the function returns the read data message. In asynchronous data reading, the application process may use an epoll mechanism to read data through event notification after the data message arrives at the socket interface, to avoid blocking to wait.

In embodiments of the present application, for a data transmission event, an input/output (I/O) scheduling process may further run in the cloud firewall service. The I/O scheduling process may be understood as a process for implementing asynchronous data transmission. A task coroutine in the application process that is of the same type as the data transmission event is woken up through modifying a task state of the task coroutine by the I/O scheduling process. In this way, the application process may complete data transmission and asynchronous data transmission is implemented in the user mode of the Linux system, which effectively improves the concurrency processing capability of the Linux system, and improves system performance.

During specific implementation, the user-mode protocol stack of the cloud firewall service sends the first data message to the first socket interface, the I/O scheduling process of the cloud firewall service marks a task state of a first task coroutine in the first application process as a ready state, and the I/O scheduling process of the cloud firewall service runs the first task coroutine, so that the first task coroutine in the first application process reads the first data message based on the first socket interface.

In other words, the first application process includes a task coroutine used to process a data transmission type. In embodiments of the present application, the first application process has a data reading requirement, and therefore the first task coroutine is used to execute a data reading task.

When the first socket interface meets the trigger condition of the data reading event, the I/O scheduling process of the cloud firewall service wakes up, by modifying the task state of the task coroutine, the first task coroutine in the first application process that is used to execute the data reading task, and notifies the first application process that the data reading task may be executed, so that the first task coroutine reads data, implementing asynchronous data reading.

In embodiments of the present application, event processing is separated from task execution, that is, the task state of the first task coroutine is first modified, and after the task state of the first task coroutine is marked as the ready state, which indicates that the first task coroutine may run, then the first task coroutine is run.

In some possible implementations, the I/O scheduling process calls a method for waking up the first task coroutine in the first application process, to mark the task state of the first task coroutine in the first application process as the ready state. In other words, In embodiments of the present application, the method for waking up the task coroutine is configured. For example, by configuring a waker method of context in future, when the trigger condition of the data transmission event (for example, the data reading event) is met, the waker method is called to mark the task state of the first task coroutine as a ready state, implementing event driving.

Because the first application process has a mapping relationship with the first socket interface, and the first application also has a mapping relationship with the first task coroutine, the first task coroutine also has a mapping relationship with the first socket interface. The first task coroutine is run by the I/O scheduling process, so that the first application process may read the first data message through the first socket interface.

In some possible implementations, the first application process calls a method for attempting data transmission, to run the first task coroutine. In other words, in embodiments of the present application, the method for attempting data transmission (for example, attempting data reading) is configured. For example, by configuring a poll method in future, after the first task coroutine is woken up, the first application process may call the poll method to read the first data message through the first socket interface, completing task scheduling.

In this way, by separating event processing from task execution, efficient event driving and task scheduling are implemented, and asynchronous data reading of the first application process is implemented when the first application process has a data reading requirement.

Further, in response to completing reading the first data message, the I/O scheduling process of the cloud firewall service may further mark the task state of the first task coroutine in the first application process as a waiting state.

For example, after the first application process cannot read the first data message, the I/O scheduling process re-marks the first task coroutine as a pending state, indicating that a current data reading task has been completed, and waiting for the first socket interface to receive a next data message before waking up the first task coroutine.

In this way, after the data reading task is completed, by modifying the task state of the first task coroutine, running of the first task coroutine is stopped in time, which reduces consumption of system resources, and improves running efficiency of the first application process.

In embodiments of the present application, by running the user-mode protocol stack in the cloud firewall service, and completing security management and data processing of network traffic in the user mode, the data reading process of the application process is enabled to bypass the kernel space, which reduces the frequency of context switches, and reduces CPU consumption in the cloud firewall service.

In addition, considering that the first data packet generated by the server may be in an encrypted form, that is, the first data message is an encrypted message, the first device may further be connected to an encryption and decryption card device, and the encryption and decryption card device is used to decrypt the first data message. In this case, a second socket interface of the first application process also runs in the user mode of the operating system of the first device. The second socket interface is associated with the encryption and decryption card device connected to the first device, that is, the second socket interface is used for data transmission between the first application process and the encryption and decryption card device.

After the first application process reads the first data message based on the first socket interface, the first application process may further write the first data message into the second socket interface, so that the encryption and decryption card device performs decryption processing on the first data message.

In other words, the first application process obtains the decrypted first data message by performing data transmission with the encryption and decryption card device, so that the first application process may normally read the data message, and complete corresponding data processing. Therefore, the data transmission method provided in embodiments of the present application may provide a bottom-layer coroutine architecture capability for an integrated hardware encryption and decryption card, to reduce adaptation costs of the encryption and decryption card.

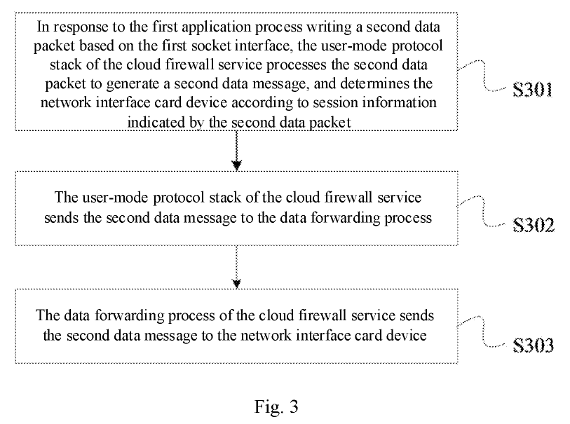

Referring to FIG. 3, for a data writing requirement of the first application process, the present application further provides a data transmission method. The method specifically includes the following steps.

S301: In response to the first application process writing a second data packet based on the first socket interface, the user-mode protocol stack of the cloud firewall service processes the second data packet to generate a second data message, and determines the network interface card device based on session information indicated by the second data packet.

The second data packet may be an application data packet generated by the first application process. In other words, the data writing requirement of the first application process is a requirement to send the second data packet. A data transmission process between the server and the first application process needs to rely on the network interface card device, that is, the second data packet generated by the first application process is first sent to the memory buffer of the network interface card device, and then sent by the network interface card device to the server.

During specific implementation, in response to there being available space in a sending buffer of the first socket interface, the first application process writes the second data packet based on the first socket interface, and the user-mode protocol stack of the cloud firewall service processes the second data packet to generate the second data message.

In other words, when the first application process has the data writing requirement, and when there is available space in the sending buffer of the first socket interface, it indicates that the first application process may write data of a data packet into the first socket interface. The first socket interface meets a trigger condition of a data writing event, and the first application process may write data.

In embodiments of the present application, for a data transmission event, an I/O scheduling process may further run in the cloud firewall service. The first application process may write the second data packet through the following steps: in response to there being available space in the sending buffer of the first socket interface, the I/O scheduling process of the cloud firewall service marks a task state of a second task coroutine in the first application process as a ready state, and the I/O scheduling process of the cloud firewall service runs the second task coroutine, so that the second task coroutine in the first application process writes the second data packet based on the first socket interface.

Because the first application process has the data writing requirement, the second task coroutine is used to execute a data writing task. When the first socket interface meets the trigger condition of the data writing event, the I/O scheduling process of the cloud firewall service wakes up, by modifying the task state of the task coroutine, the second task coroutine in the first application process that is used to execute the data writing task, and notifies the first application process that the data writing task may be executed, so that the second task coroutine writes data, implementing asynchronous data writing.

Similarly, in embodiments of the present application, event processing is separated from task execution, that is, the task state of the second task coroutine is first modified, and after the task state of the second task coroutine is marked as the ready state, which indicates that the second task coroutine may run, then the second task coroutine is run.

In some possible implementations, the I/O scheduling process calls a method for waking up the second task coroutine in the first application process, to mark the task state of the second task coroutine in the first application process as the ready state. For example, by configuring a waker method of context in future, when the trigger condition of the data transmission event (for example, the data writing event) is met, the waker method is called to mark the task state of the second task coroutine as a ready state, implementing event driving.

In some possible implementations, the first application process calls a method for attempting data transmission, to run the second task coroutine. For example, by configuring a poll method in future, after the second task coroutine is woken up, the first application process may call the poll method to write the second data message through the first socket interface, completing task scheduling.

In this way, by separating event processing from task execution, efficient event driving and task scheduling are implemented, and asynchronous data writing of the first application process is implemented when the first application process has the data writing requirement.

Further, in response to completing writing the second data packet or there being no available space in the sending buffer of the first socket interface, the I/O scheduling process of the cloud firewall service marks the task state of the second task coroutine in the first application process as the waiting state.

The first task coroutine is re-marked as the pending state by the I/O scheduling process, indicating that a current data writing task has been completed, and waiting for there to be available space in the sending buffer of the first socket interface before waking up the second task coroutine again.

In this way, after the data writing task is completed, by modifying the task state of the second task coroutine, running of the second task coroutine is stopped in time, which reduces consumption of system resources, and improves running efficiency of the first application process.

In some embodiments, considering that the first application process may send an encrypted data message to the server, that is, the second data packet is an encrypted data packet, the first device may further be connected to an encryption and decryption card device, and the encryption and decryption card device is used to perform encryption to obtain the second data packet. In this case, a second socket interface of the first application process also runs in the user mode of the operating system of the first device. The second socket interface is associated with the encryption and decryption card device connected to the first device, that is, the second socket interface is used for data transmission between the first application process and the encryption and decryption card device.

The first application process writes an initial data packet into the second socket interface, so that the encryption and decryption card device performs encryption processing on the initial data packet to obtain the second data packet.

In other words, the first application process obtains the encrypted second data packet by performing data transmission with the encryption and decryption card device, so that the first application process may send encrypted data to the server, to ensure data transmission security. Therefore, the data transmission method provided in embodiments of the present application may provide a bottom-layer coroutine architecture capability for an integrated hardware encryption and decryption card, reducing adaptation costs of the encryption and decryption card.

Similarly, after the first application process writes the second data packet into the first socket interface, the user-mode protocol stack may process the second data packet. For example, the user-mode protocol stack parses and assembles the second data packet based on a set of protocols related to a network communication process in the protocol stack, and re-organizes and mounts the second data packet into an ordered queue to form the second data message that meets the data transmission protocol.

The user-mode protocol stack may further parse the second data packet to obtain session information, for example, five-tuple information (that is, a source IP address, a source port, a destination IP address, a destination port, and a transport layer protocol). Then, the destination port in the five-tuple information is matched against a port associated with the network interface card device, to determine the network interface card device for sending the second data message to the server.

S302: The user-mode protocol stack of the cloud firewall service sends the second data message to the data forwarding process.

S303: The data forwarding process of the cloud firewall service sends the second data message to the network interface card device.

Similarly, before the second data message is sent to the network interface card device, the cloud firewall service needs to perform security management on the second data message. Specifically, the data forwarding process of the cloud firewall service filters the second data message based on a preset filtering rule, and forwards the second data message allowed to pass to the network interface card device.

For example, the data forwarding process may parse the second data message, perform ACL matching on the second data message, determine whether the second data message is secure, send the second data message confirmed to be secure to the network interface card device, and discard an insecure second data message. In this way, the security management function of the cloud firewall service is implemented, preventing the insecure second data message from being transmitted to the network interface card device, and ensuring security of network transmission.

Similarly, because the data forwarding process and the user-mode protocol stack belong to two different processes in the user mode and cannot directly transmit a data packet, in the cloud firewall service, the user-mode protocol stack may inject the second data message into the data forwarding process through shared memory, so that the data forwarding process filters the second data message.

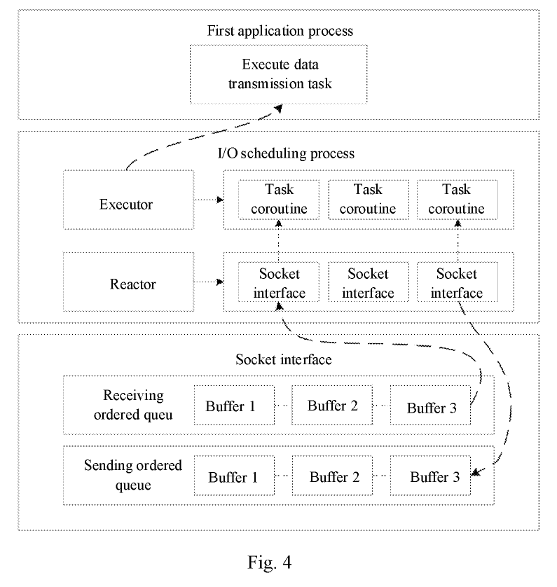

A specific implementation is provided below with reference to an example. FIG. 4 is a schematic flowchart of a data transmission method. The I/O scheduling process is implemented through a reactor-executor architecture for efficiently processing events and managing task execution. The reactor is configured to detect and wait for an event to occur, and the executor is configured to schedule a task and execute the task.

During specific implementation, the first socket interface provides two ordered queues: a receiving ordered queue and a sending ordered queue. Where, the receiving ordered queue may be understood as a receiving buffer, and the sending ordered queue may be understood as a sending buffer. After receiving the first data message sent by the user-mode protocol stack, the first socket interface mounts the first data message to respective buffers in the receiving ordered queue. After the first application process writes the second data packet into the first socket interface, the second data packet is mounted to respective buffers in the sending ordered queue.

I/O scheduling is performed for a data transmission event. The reactor detects the data transmission event, and when the first socket interface meets a trigger condition of a first data transmission event, the reactor may mark a task state of a task coroutine in the first application process as a ready state, and distribute the task coroutine to the executor. For example, the task coroutine is added to running task, to wait to be scheduled to run. The executor runs the task coroutine. For example, the executor may poll running task, and execute, on a thread, the task coroutine in the ready state in running task, that is, the first application process executes a data transmission task on the thread through the first socket interface. In this way, asynchronous data transmission is implemented in the user mode of the operating system of the first device.

The data transmission method provided in embodiments of the present application is described in detail above with reference to FIGS. 1 to 4. An apparatus and a device provided in embodiments of the present application are described below with reference to the drawings.

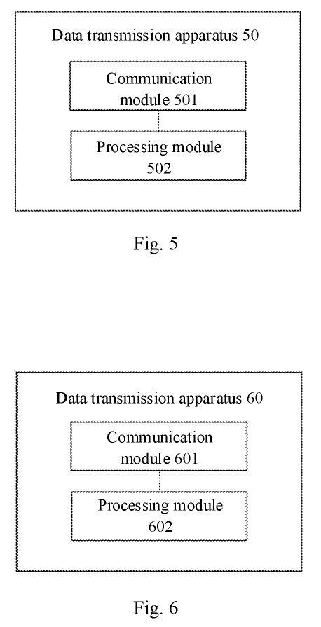

FIG. 5 is a schematic diagram of a structure of a data transmission apparatus. The apparatus is deployed in a first device. A cloud firewall service, a first application process, and a first socket interface of the first application process run in a user mode of an operating system of the first device. A data forwarding process and a user-mode protocol stack corresponding to the first application process run in the cloud firewall service. The first socket interface is associated with a network interface card device connected to the first device. The apparatus 50 includes:

A communication module 501, configured to receive a first data packet sent by the network interface card device, and forward the first data packet to the user-mode protocol stack.

A processing module 502, configured to process the first data packet to generate a first data message, and determine the first socket interface based on session information indicated by the first data packet.

The communication module 501 is further configured to send the first data message to the first socket interface, so that the first application process reads the first data message based on the first socket interface.

In some possible implementations, the communication module 501 is further configured to:

receive the first data packet sent by the network interface card device based on a direct memory access technology.

In some possible implementations, the communication module 501 is further configured to:

filter the first data packet based on a preset filtering rule, and forward the first data packet allowed to pass to the user-mode protocol stack.

In some possible implementations, the communication module 501 is further configured to:

send the first data message to the first socket interface;

mark a task state of a first task coroutine in the first application process as a ready state, where the first task coroutine is configured to execute a data reading task;

run the first task coroutine, such that the first task coroutine in the first application process reads the first data message based on the first socket interface.

In some possible implementations, the communication module 501 is further configured to:

in response to completing reading the first data message, mark the task state of the first task coroutine in the first application process as a waiting state.

In some possible implementations, a second socket interface of the first application process also runs in the user mode of the operating system of the first device. The second socket interface is associated with an encryption and decryption card device connected to the first device. The first data message is an encrypted message. The communication module 501 is further configured to:

write the first data message into the second socket interface, so that the encryption and decryption card device performs decryption processing on the first data message.

The data transmission apparatus 50 according to embodiments of the present application may correspond to performing the method described in embodiments of the present application, and the foregoing and other operations and/or functions of the modules/units of the data transmission apparatus 50 are respectively intended to implement the corresponding procedures of the methods in the embodiments shown in FIG. 1. For the sake of brevity, details are not described herein again.

FIG. 6 is a schematic diagram of a structure of a data transmission apparatus. The apparatus is deployed in a first device. A cloud firewall service, a first application process, and a first socket interface of the first application process run in a user mode of an operating system of the first device. A data forwarding process and a user-mode protocol stack corresponding to the first application process run in the cloud firewall service. The first socket interface is associated with a network interface card device connected to the first device. The apparatus 60 includes:

A processing module 601, configured to: in response to the first application process writing a second data packet based on the first socket interface, process the second data packet to generate a second data message, and determine the network interface card device based on session information indicated by the second data packet.

A communication module 602, configured to send the second data message to the data forwarding process.

The communication module 602 is further configured to send the second data message to the network interface card device.

In some possible implementations, the communication module 602 is further configured to:

filter the second data message based on a preset filtering rule, and forward the second data message allowed to pass to the network interface card device.

In some possible implementations, the processing module 601 is further configured to:

in response to there being available space in a sending buffer of the first socket interface, the first application process writes the second data packet based on the first socket interface, and process the second data packet to generate the second data message.

In some possible implementations, the processing module 601 is further configured to:

in response to there being available space in the sending buffer of the first socket interface, mark a task state of a second task coroutine in the first application process as a ready state, where the second task coroutine is configured to execute a data writing task;

run the second task coroutine, such that the second task coroutine in the first application process writes the second data packet based on the first socket interface.

In some possible implementations, the processing module 601 is further configured to:

in response to completing writing the second data packet or there being no available space in the sending buffer of the first socket interface, mark the task state of the second task coroutine in the first application process as a waiting state.

In some possible implementations, a second socket interface of the first application process also runs in the user mode of the operating system of the first device. The second socket interface is associated with an encryption and decryption card device connected to the first device. The processing module 601 is further configured to:

write an initial data packet into the second socket interface, so that the encryption and decryption card device performs encryption processing on the initial data packet to obtain the second data packet.

The data transmission apparatus 60 according to embodimentS of the present application may correspond to performing the method described In embodiments of the present application, and the foregoing and other operations and/or functions of the modules/units of the data transmission apparatus 60 are respectively intended to implement the corresponding procedures of the methods in the embodiments shown in FIG. 3. For the sake of brevity, details are not described herein again.

Embodiments of the present application further provides an electronic device. The electronic device is further configured to implement functions of the data transmission apparatus 50 or the data transmission apparatus 60 in embodiments shown in FIGS. 5 or 6.

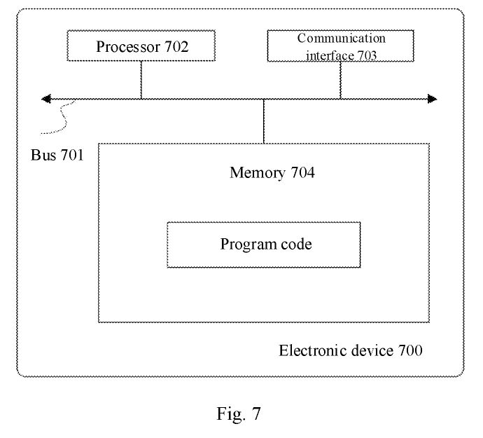

FIG. 7 is a schematic diagram of a structure of an electronic device 700. As shown in FIG. 7, the electronic device 700 includes a bus 701, a processor 702, a communication interface 703, and a memory 704. The processor 702, the memory 704, and the communication interface 703 communicate with each other through the bus 701.

The bus 701 may be a peripheral component interconnect (PCI) bus, an extended industry standard architecture (EISA) bus, or the like. The bus may be classified into an address bus, a data bus, a control bus, and the like. For ease of representation, only a thick line is used to represent the bus in FIG. 7, but this does not mean that there is only one bus or one type of bus.

The processor 702 may be any one or more of a central processing unit (CPU), a graphics processing unit (GPU), a microprocessor (MP), a digital signal processor (DSP), and the like.

The communication interface 703 is configured to communicate with an external device. For example, the communication interface 703 may be configured to communicate with a terminal.

The memory 704 may include a volatile memory, for example, a random access memory (RAM). The memory 704 may further include a non-volatile memory, for example, a read-only memory (ROM), a flash memory, a hard disk drive (HDD), or a solid state drive (SSD).

The memory 704 stores executable code, and the processor 702 executes the executable code to perform the foregoing data transmission method.

Specifically, when the embodiments shown in FIGS. 5 or 6 are implemented, and the modules or units of the data transmission apparatus 50 or the data transmission apparatus 60 described in the embodiments of FIGS. 5 or 6 are implemented by software, software or program code required to perform functions of the modules/units in FIGS. 5 or 6 may be partially or entirely stored in the memory 704. The processor 702 executes program code corresponding to the units stored in the memory 704, to perform the foregoing data transmission method.

Embodiments of the present application further provides a computer-readable storage medium. The computer-readable storage medium may be any usable medium that may be stored by a computing device, or a data storage device, such as a data center, that includes one or more usable media. The usable medium may be a magnetic medium (for example, a floppy disk, a hard disk, or a magnetic tape), an optical medium (for example, a DVD), a semiconductor medium (for example, a solid-state drive), or the like. The computer-readable storage medium includes instructions, and the instructions instruct the computing device to perform the foregoing data transmission method.

Embodiments of the present application further provides a computer program product that includes one or more computer instructions. When the computer instructions are loaded and executed on a computing device, the procedure or functions according to the embodiments of the present application are all or partially generated.

The computer instructions may be stored in a computer-readable storage medium, or may be transmitted from one computer-readable storage medium to another computer-readable storage medium. For example, the computer instructions may be transmitted from one website, computer, or data center to another website, computer, or data center in a wired (for example, a coaxial cable, an optical fiber, or a digital subscriber line (DSL)) or wireless (for example, infrared, wireless, or microwave) manner.

When the computer program product is executed by a computer, the computer executes any one of the foregoing data transmission methods. The computer program product may be a software installation package, and when any one of the foregoing data transmission methods needs to be used, the computer program product may be downloaded and executed on the computer.

The flowcharts and block diagrams in the drawings illustrate the possibly implemented architectures, functions, and operations of the system, the method, and the computer program product according to the embodiments of the present application. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units involved in the embodiments of the present application may be implemented by software or by hardware. The name of a unit/module does not constitute a limitation on the unit itself in some cases.

The functions described herein may be performed at least in part by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the embodiments of the present application, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

It should be noted that the embodiments in this specification are described in a progressive manner. Each embodiment focuses on the differences from other embodiments. For the same and similar parts between the embodiments, refer to each other. For the system or apparatus disclosed in the embodiments, because it corresponds to the method disclosed in the embodiments, the description is relatively simple. For related parts, refer to the description of the method.

It should be understood that in the present application, "at least one item" means one or more, and "a plurality of" means two or more. "And/or" describes an association relationship between associated objects, and represents that three relationships may exist. For example, "A and/or B" may represent the following three cases: only A exists, only B exists, and both A and B exist, where A and B may be singular or plural. The character "/" generally indicates an "or" relationship between the associated objects. "At least one of the following items (pieces)" or a similar expression thereof indicates any combination of these items, including a single item (piece) or any combination of a plurality of items (pieces). For example, at least one of a, b, or c may represent: a, b, c, "a and b", "a and c", "b and c", or "a, b, and c", where a, b, and c may be singular or plural.

It should be further noted that in this specification, relational terms such as "first" and "second" are used only to distinguish one entity or operation from another entity or operation, and do not necessarily require or imply any actual relationship or order between these entities or operations. Moreover, the terms "include", "contain", or any other variant thereof are intended to cover non-exclusive inclusion, so that a process, method, object, or device that includes a list of elements includes not only those elements, but also other elements not explicitly listed or elements inherent to such a process, method, object, or device. Without further restrictions, an element defined by the phrase "includes a" does not exclude the existence of other identical elements in the process, method, object, or device that includes the element.

Steps of a method or an algorithm described in conjunction with the embodiments disclosed herein may be directly implemented in hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable magnetic disk, a CD-ROM, or a storage medium of any other form known in the art.

The foregoing description of the disclosed embodiments enables those skilled in the art to implement or use the present application. Various modifications to these embodiments will be readily apparent to those skilled in the art, and the generic principles defined herein may be implemented in other embodiments without departing from the spirit or scope of the present application. Therefore, the present application is not limited to the embodiments shown herein, but is to be accorded the widest scope consistent with the principles and novel features disclosed herein.

1. A data transmission method, applied to a first device, wherein a first application process and a first socket interface of the first application process run in the first device, and the first socket interface is associated with a network interface card device connected to the first device, and the method comprises:
receiving a first data packet sent by the network interface card device;
processing the first data packet to generate a first data message, and determining the first socket interface according to session information indicated by the first data packet;
sending the first data message to the first socket interface, such that the first application process reads the first data message based on the first socket interface.

2. The method of claim 1, wherein a cloud firewall service, the first application process, and the first socket interface of the first application process run in a user mode of an operating system of the first device, and the method is performed by the cloud firewall service.

3. The method of claim 2, wherein a data forwarding process runs in the cloud firewall service,
the data forwarding process of the cloud firewall service receives the first data packet sent by the network interface card device.

4. The method of claim 2, wherein a user-mode protocol stack corresponding to the first application process runs in the cloud firewall service,
the user-mode protocol stack of the cloud firewall service processes the first data packet to generate the first data message, and determines the first socket interface according to the session information indicated by the first data packet, and
the user-mode protocol stack of the cloud firewall service sends the first data message to the first socket interface, such that the first application process reads the first data message based on the first socket interface.

5. The method of claim 1, wherein receiving the first data packet sent by the network interface card device comprises:
receiving the first data packet sent by the network interface card device based on a direct memory access technology.

6. The method of claim 2, wherein a user-mode protocol stack corresponding to the first application process runs in the cloud firewall service, the data forwarding process of the cloud firewall service forwards the first data packet to the user-mode protocol stack,
forwarding the first data packet to the user-mode protocol stack comprises:
filtering the first data packet based on a preset filtering rule, and forwarding the first data packet allowed to pass to the user-mode protocol stack.

7. The method of claim 2, wherein an input/output scheduling process runs in the cloud firewall service, and sending the first data message to the first socket interface, such that the first application process reads the first data message based on the first socket interface comprises:
sending the first data message to the first socket interface;
marking, by the input/output scheduling process of the cloud firewall service, a task state of a first task coroutine in the first application process as a ready state, wherein the first task coroutine is used to execute a data reading task; and
running, by the input/output scheduling process of the cloud firewall service, the first task coroutine, such that the first task coroutine in the first application process reads the first data message based on the first socket interface.

8. The method of claim 7, further comprising:
in response to completing reading the first data message, marking, by the input/output scheduling process of the cloud firewall service, the task state of the first task coroutine in the first application process as a waiting state.

9. The method of claim 1, wherein a second socket interface of the first application process also runs in the first device, the second socket interface is associated with an encryption and decryption card device connected to the first device, and the first data message is an encrypted message; and after the first application process reads the first data message based on the first socket interface, the method further comprises:
writing, by the first application process, the first data message into the second socket interface, so that the encryption and decryption card device performs decryption processing on the first data message.

10. A data transmission method, applied to a first device, wherein a first application process and a first socket interface of the first application process run in the first device, and the first socket interface is associated with a network interface card device connected to the first device, and the method comprises:
in response to the first application process writing a second data packet based on the first socket interface, processing the second data packet to generate a second data message, and determining the network interface card device according to session information indicated by the second data packet;
sending the second data message to the network interface card device.

11. The method of claim 10, wherein a cloud firewall service, the first application process, and the first socket interface of the first application process run in a user mode of an operating system of the first device, and the method is performed by the cloud firewall service.

12. The method of claim 11, wherein a data forwarding process and a user-mode protocol stack corresponding to the first application process run in the cloud firewall service,
the user-mode protocol stack of the cloud firewall service processes the second data packet to generate a second data message, and determines the network interface card device according to session information indicated by the second data packet;
the user-mode protocol stack of the cloud firewall service sends the second data message to the data forwarding process;
the data forwarding process of the cloud firewall service sends the second data message to the network interface card device.

13. The method of claim 12, wherein sending, by the data forwarding process, the second data message to the network interface card device comprises:
filtering the second data message based on a preset filtering rule, and forwarding the second data message allowed to pass to the network interface card device.

14. The method of claim 11, wherein:
in response to there being available space in a sending buffer of the first socket interface, the first application process writes the second data packet based on the first socket interface.

15. The method of claim 11, wherein an input/output scheduling process runs in the cloud firewall service, and the first application process writes the second data packet through following steps:
in response to there being available space in the sending buffer of the first socket interface, marking, by the input/output scheduling process of the cloud firewall service, a task state of a second task coroutine in the first application process as a ready state, wherein the second task coroutine is used to execute a data writing task;
running, by the input/output scheduling process of the cloud firewall service, the second task coroutine, such that the second task coroutine in the first application process writes the second data packet based on the first socket interface.

16. The method of claim 15, further comprising:
in response to completing writing the second data packet or there being no available space in the sending buffer of the first socket interface, marking, by the input/output scheduling process of the cloud firewall service, the task state of the second task coroutine in the first application process as a waiting state.

17. The method of claim 10, wherein a second socket interface of the first application process also runs in the first device, and the second socket interface is associated with an encryption and decryption card device connected to the first device, and before in response to the first application process writing the second data packet based on the first socket interface, processing the second data packet to generate the second data message, the method further comprises:
writing, by the first application process, an initial data packet into the second socket interface, so that the encryption and decryption card device performs encryption processing on the initial data packet to obtain the second data packet.

18. An electronic device, comprising a processor and a memory, wherein
the processor is configured to execute instructions stored in the memory, to enable the electronic device to perform a data transmission method, the data transmission method applied to a first device, wherein a first application process and a first socket interface of the first application process run in the first device, and the first socket interface is associated with a network interface card device connected to the first device, and the method comprises:
receiving a first data packet sent by the network interface card device;
processing the first data packet to generate a first data message, and determining the first socket interface according to session information indicated by the first data packet;
sending the first data message to the first socket interface, such that the first application process reads the first data message based on the first socket interface, or
the method comprises:
in response to the first application process writing a second data packet based on the first socket interface, processing the second data packet to generate a second data message, and determining the network interface card device according to session information indicated by the second data packet;
sending the second data message to the network interface card device.

19. The electronic device of claim 18, wherein a cloud firewall service, the first application process, and the first socket interface of the first application process run in a user mode of an operating system of the first device, and the method is performed by the cloud firewall service.

20. A non-transitory computer-readable storage medium, comprising instructions, wherein the instructions instruct an electronic device to perform the method of claim 1.
